(19) United States
(12) Patent Application Publication
(10) Pub. No.: US 2004/0125737 A1
(43) Pub. Date: Jul. 1, 2004

(54) Optical head and optical disc apparatus

(75) Inventors: Katsuo Iwata, Tokyo (JP); Sumitaka Maruyama, Yokohama-shi (JP); Kazuhiro Nagata, Yokohama-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/651,039

(22) Filed: Aug. 29, 2003

(30) Foreign Application Priority Data
Dec. 27, 2002 (JP) 2002-382259

(51) Int. Cl. G11B 7/00

(52) U.S. Cl. 369/121

(57) ABSTRACT

An optical head and optical disc apparatus according to the present invention can guide each of optional light rays of different wavelength from a plurality of light sources to a recording medium through a single optical system, and can play back the signal from the reflected light from the recording medium through a single light receiving system.

### CROSS-REFERENCE TO RELATED APPLICATIONS

This application is based upon and claims the benefit of priority from the prior Japanese Patent Application No. 2002-382259, filed Dec. 27, 2002, the entire contents of which are incorporated herein by reference.

### BACKGROUND OF THE INVENTION

1. Field of the Invention

The present invention relates to an optical head and optical disc apparatus which record and playback information on/from an optical information recording medium.

2. Description of the Related Art

As a medium to record information on a recording medium using a laser beam, for example, an optical disc of CD or DVD standard has been widely used. Recently, a high-density optical disc which uses a semiconductor laser element as a light source capable of outputting a blue or purple shorter wavelength light, has been standardized.

Therefore, it is difficult to provide drive units for various recording media in one optical disc apparatus. A drive unit common to at least CD and DVD has been demanded.

However, if one optical head is prepared for each one of the semiconductor elements capable of outputting different wavelength laser beams, it becomes impossible to increase the integration density of packaging a light source and other optical parts, and it is difficult to make the drive unit thin and compact.

The Jpn. Pat. Appln. KOKAI Publication No. 2002-25104 disclosed the optical head unit in which semiconductor laser elements capable of outputting different wavelength laser beams are provided with the emitting positions set close to each other, so that at least two laser beam spots of different wavelengths can be supplied to an optical disc. This optical head unit employs a monolithic semiconductor laser element which has two light-emitting parts capable of outputting two laser beams of different wavelengths, and a semiconductor laser element which outputs a laser beam whose wavelength is different from the above two laser beams. By arranging the semiconductor laser element and monolithic semiconductor laser element parallel to each other, three laser beam spots of different wavelength can be obtained by one head.

However, in the optical head unit disclosed by the above patent application, the optical axes of all laser beams emitted from the three light-emitting points (light sources) are not identical with the designed optical axes of the optical head. Thus, when a laser beam emitted from a semiconductor laser element is guided on an optical disc, the beam from the light-emitting point located apart from the optical axis of the optical head is obliquely guided on the recording surface of an optical disc. In this case, influence of the aberration component increases, and correct stable recording and playback become difficult.

### BRIEF SUMMARY OF THE INVENTION

It is an object of the present invention is to provide an optical head and optical disc unit which can guide light of different wavelengths from a light source to a recording medium through a single optical system, and can play a signal from reflected light from a recording medium through a single light-receiving system.

According to an aspect of the present invention, there is provided an optical head comprising: a light source which performs recording and/or playback of the information on the optical disc, an object lens which focuses the light ray emitted from the light source to the information recording layer through the light transparent layer of the optical disc, a branching portion which branches reflected luminous flux from the optical disc to between the light source and the object lens, a detection lens which focuses the light ray branched by the branching portion, and a light receiving portion which receives light ray and generates a light intensity signal according to the intensity of the received light ray, wherein the light source has plural light-emitting parts which each output light ray of a different wavelength; and an optional light-emitting part among the light-emitting parts is arranged, so that the optical axis of the output light ray is located on the optical axis of the optical system.

According to another aspect of the present invention, there is provided an optical head comprising: an optical disc apparatus comprising: an optical head having a light source which is necessary to perform recording and/or playback of information on the optical disc, an object lens which focuses the light emitted from the light source on to the information recording layer through the light transparent layer of the optical disc, a branching portion which branches reflected luminous flux from the optical disc to between the light source and the object lens, a detection lens which focuses the light branched by the branching portion, and a light receiving portion which receives light and generates a light intensity signal according to the intensity of the received light ray, wherein the light source of the optical head has plural light-emitting parts which each output light of a different wavelength, and one of the light-emitting parts is arranged on the optical axis of the optical system; a laser drive circuit which outputs light with a predetermined wavelength from an optional light-emitting part of the optical head; a signal processor which plays information recorded on the recording medium, based on the signal output from the photodetector of the optical head; and a motor which rotates the recording medium at a predetermined speed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIGS. 1A, 1B and 1C show a schematic diagram explaining an optical head embodying the present invention;

FIGS. 2A and 2B show a schematic diagram explaining a light source unit applicable to the optical head shown in FIG. 1A;

FIGS. 3A and 3B show a schematic diagram explaining the light source unit applicable to the optical head shown in FIG. 1A;

FIG. 4 is a schematic diagram explaining the light source unit applicable to the optical head shown in FIG. 1A;

FIG. 5 is a schematic diagram explaining the light source unit applicable to the optical head shown in FIG. 1A;

FIG. 6 is a schematic diagram explaining the light source unit applicable to the optical head shown in FIG. 1A;

FIGS. 7A, 7B and 7C show a schematic diagram explaining the light source unit applicable to the optical head shown in FIG. 1A; and

FIG. 8 is a schematic diagram explaining an optical disc apparatus which uses the optical head shown in FIG. 1A.

### DETAILED DESCRIPTION OF THE INVENTION

Hereinafter the embodiments of the present invention will be explained in detail with reference to the accompanying drawings. As an information recording medium used for the optical head embodying the invention, a phase changing optical disc (an information recording medium as an object of recording and/or playback) is taken as an example. However, the optical head is widely applicable also to an information recording medium having a light transparent layer, and the disc may be replaced by an information recording medium for only one time recording, a play-only optical disc, a magneto optical disc and an optical card. In the following embodiments, an optical pickup and optical disc unit which have three light source of different wavelength will be explained, but it is of course that the embodiments are applicable to an optical disc unit having four more light sources.

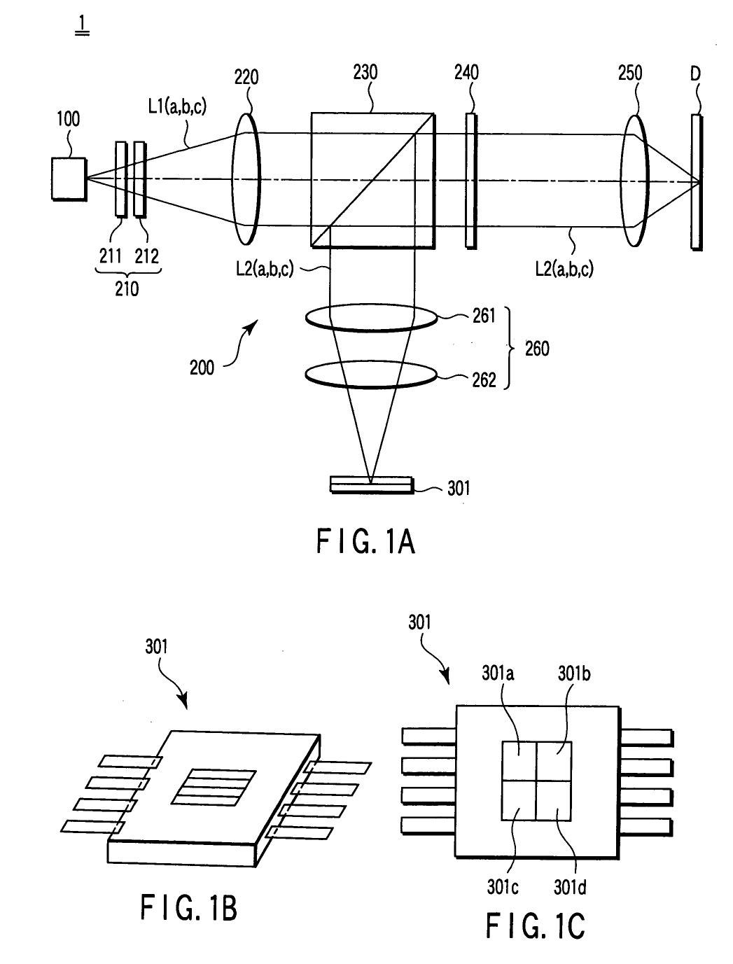

FIGS. 1A, 1B and 1C show a schematic diagram explaining an example of an optical head of the present invention.

As shown in FIG. 1A, an optical head 1 includes a light source unit 100 which can output laser beams with predetermined wavelengths; an optical system 200 which guides the light emitted from the light source unit 100 to an optical disc D as an information recording medium, and guides the light returned from the optical disc D in a predetermined direction; and a photodetector 301 which receives the light returned from the optical disc D, and outputs an electric signal corresponding to that light.

The light source unit 100 includes at least two semiconductor laser elements (light-emitting parts) which can emit laser beams of a different wavelength, as explained in detail later. In this embodiment, the light source unit 100 includes a semiconductor laser element which can output a blue laser beam (e.g., a wavelength of 405 nm) capable of recording information of 20G bytes on a CD-size optical disc; a semiconductor laser element which can output a red laser beam (e.g., a wavelength of 650 nm) used for recording and/or playback of information on/from a widely spread DVD standard optical disc; and a semiconductor laser element which can output a near infrared laser beam (e.g., a wavelength of 780 nm) used for recording and/or playback of information on/from a well-known CD standard optical disc.

The optical system 200 includes a compensation optical member 210 (diffraction elements 211, 212); a collimator lens 220 which parallelizes the cross section of a divergent laser beam; a polarized beam splitter 230 which separates the laser beam directed from the optical source unit 100 on to the optical disc D, from the laser beam returned from the optical disc D; a ¼ wave plate 240 which matches isolation of the laser beam directed on to the optical disc D, from the light returned from the optical disc; an object lens 250 which focuses the light directed on to the optical disc D at a predetermined position on the recording surface of the optical disc D, and captures the laser beam reflected from the optical disc D; and a detection optical system 260 (a condenser lens 261 and a cylindrical lens 262) which obtains the information to control the position of the object lens 250.

The compensation optical member 210 includes first diffraction element 211 and second diffraction element 212. The diffraction elements 211 and 212 have the diffraction efficiency and diffraction order corresponding to the wavelength.

The first diffraction element 211 can transmit blue and red laser beams, and primarily diffracts an infrared laser beam. The diffraction element 212 can transmit blue and infrared laser beams, and primarily diffracts a red laser beam. The diffraction efficiency of the diffraction elements 211 and 212 can be easily controlled by controlling the depth of the grid groove of each diffraction element. The diffraction order of the diffraction elements 211 and 212 can be easily controlled by making the grid groove of each diffraction element saw-like and changing the inclination angle of the inclined part.

The first diffraction element 211 is given a grid groove pattern which compensates the chromatic/spherical aberration caused by combination with the collimator lens 220, with respect to an infrared laser beam. The second diffraction element 212 is given a grid groove pattern which compensates the chromatic/spherical aberration caused by combination with the collimator lens 220, with respect to a red laser beam.

The detection optical system 260 uses a well-known astigmatism system comprising a condenser lens 261 and a cylindrical lens 262, for example.

The photodetector 301 may be either the parallel light receiving areas as shown in FIG. 1B or the well-know 1^{st} to 4^{th} light receiving areas 301a, 301b, 301c and 301d divided by a division line orthogonal to each other as shown in FIG. 1C.

In the above-mentioned optical head 1, a laser beam L1 (a, b, c) emitted from a light source unit 100 is given a predetermined optical characteristic by the diffraction elements 211 and 212, and then collimated by the collimator lens 220, and guided to the polarized beam splitter 230.

The laser beam L1 directed from the polarized beam splitter 230 toward the optical disc D is converted by the ¼ wave plate 240 from a linear polarized light to a circular polarized light, and then focused at a predetermined position on the recording surface of the optical disc D.

The laser beam L1 guided on the optical disc D is reflected by the recording surface, and returned to the object lens 250 as a reflected laser beam L2 (a, b, c).

The reflected laser beam L2 returned to the object lens 250 is applied to the ¼ wave plate 240 to be matched in the isolation to that before reflected by the optical disc D, and guided to the polarized beam splitter 230.

The reflected laser beam L2 guided to the polarized beam splitter 230 is reflected by the polarized beam split surface toward the detection optical system (the astigmatism system) 260, though not explained in detail.

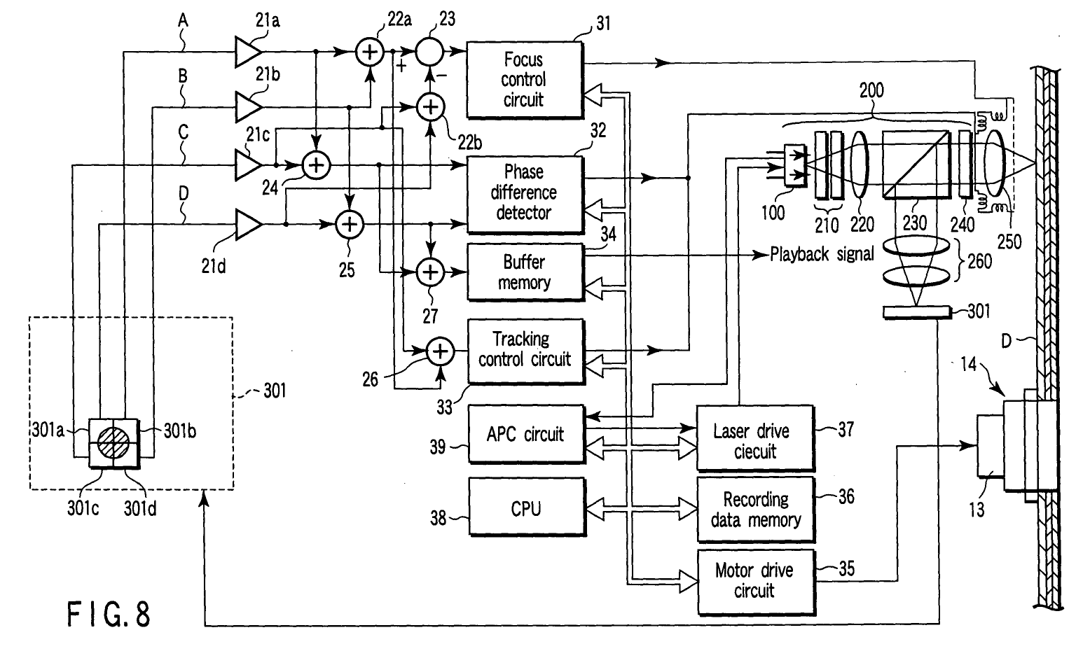

The reflected laser beam L2 is given a predetermined image forming characteristic by the astigmatism detection system 260, and forms an image in a predetermined light receiving area of the photodetector 301, according to the predetermined image forming characteristic. The detection signals (outputs) obtained by each light receiving area of the photodetector 301 are converted to a playback signal, a focus error signal and a track error signal, by a signal processor which is to be explained later with reference to FIG. 8.

Explanation will now be given on a light source applicable to the optical head 1 shown in FIG. 1A.

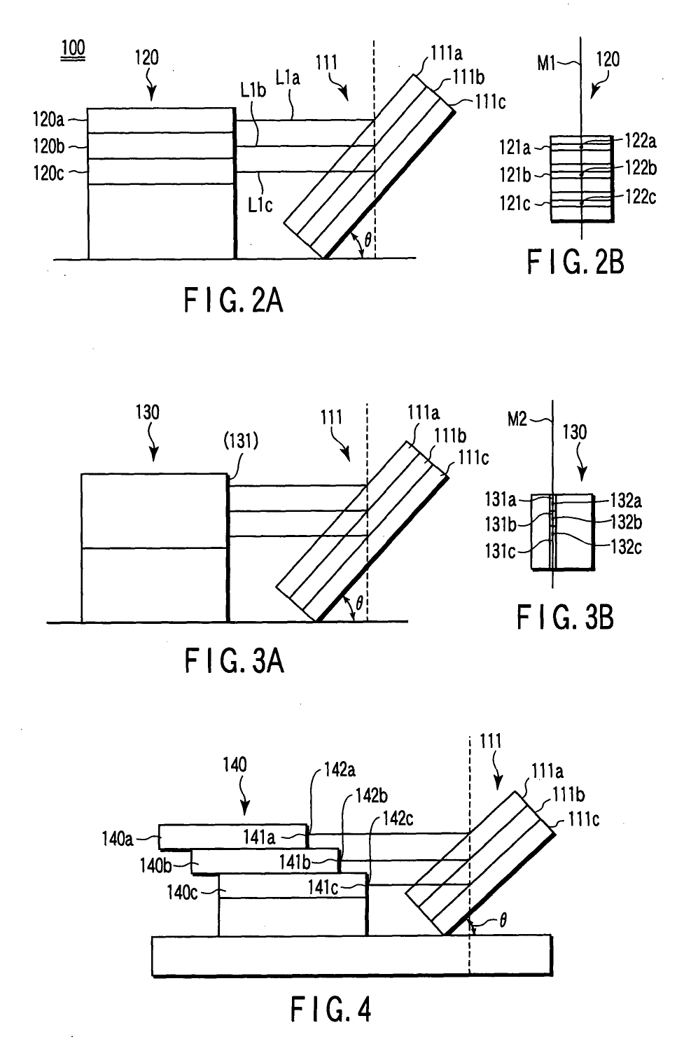

As shown in FIG. 2A, the light source unit 100 includes a semiconductor laser unit 120 which can output at least two or more laser beams and three in this embodiment with different wavelengths, and a wavelength selector film block 111 which can reflect the laser beams of optional wavelengths from the semiconductor laser unit 120 by a layer different for each wavelength.

The semiconductor laser unit 120 has first semiconductor laser element 120a, second semiconductor laser element 120b and third semiconductor laser element 120c.

The first laser element 120a emits a blue laser beam (e.g., a light source wavelength of 405 nm), as explained before. The second laser element 120b emits a red laser beam (e.g., a light source wavelength of 650 nm), as explained before. The third laser element 120c emits an infrared laser beam (e.g., a light source wavelength of 780 nm).

As shown in FIG. 2B, the semiconductor laser unit 120 controls the laser beam emitting position from the light source in the vertical direction to an active layer. Namely, the active layers 121a, 121b and 121c of the laser elements 120a, 120b and 120c are stacked in the direction vertical to the area direction of the active layers. The laser element 120a and the laser element 120b have a predetermined interval between the active layer 121a and the active layer 121b. Also the laser element 120b and the laser element 120c have a predetermined interval between the active layer 121b and the active layer 121c.

Further, the emitting points 122a, 122b and 122c corresponding to the active layers 121a, 121b and 121c are located on a predetermined straight line M1 along the direction vertical to the area direction of each active layer, when viewed from the laser beam emitting side. With the semiconductor laser unit 120 which controls the emitting position in the direction vertical to the active layer, it is possible to accurately control the interval between the active layers which can output each laser beams of predetermined wavelength.

The wavelength selector film block 111 includes wavelength selector films 111a to 111c which have the transmissivity and reflectivity corresponding to the light rays emitted from the semiconductor laser elements 120a to 120c.

More particularly, the wavelength selector film 111a transmits efficiently the laser beam L1b from the red semiconductor laser element 120b, and the laser beam L1c from the infrared semiconductor laser element 120c, and reflects efficiently the laser beam L1a emitted from the blue semiconductor laser element 120a. The wavelength selector film 111b transmits efficiently the laser beam L1c from the infrared semiconductor laser element 120c, and reflects efficiently the laser beam L1b from the infrared semiconductor laser element 120b. The wavelength selector film 111c reflects efficiently the laser beam L1c from the infrared semiconductor laser element 120c.

The film thickness of the wavelength selector films 111a to 111c and the angle θ1 when the wavelength selector film block 111 is located are set, so that each principal ray of the laser beams (L1a, L1d and L1c) reflected by each wavelength selector film (111a, 111b and 111c) coincide with the optical axis of a optical system defined in the space up to the object lens 250.

As explained above, the semiconductor laser unit 120 can guide each laser beam of a different wavelength according to the optical disc standards, on the optical disc, as a laser beam with the improved aberration caused by the different wavelength, when recording and/or playing back information on/from the optical disc D of optional standard.

For example, the laser beam L1a from the blue semiconductor laser 120a is reflected by the selector film 111a, transmitted through the diffraction elements 211 and 212, passed through the collimator lens 220, the polarized beam splitter 230 and the ¼ wave plate 240, in this order, and guided to the object lens 250, and focused on the recording surface of the optical disc D through the object lens 250.

The laser beam L2a reflected by the optical disc D goes through the object lens 250 and the ¼ wave plate 240, returns to the polarized beam splitter 230, where the beam is reflected, and guided to the detection optical system 260.

The reflected laser beam L2a guide to the detection optical system 260 is given a predetermined image forming characteristic corresponding to the detection area pattern of the photodetector 301, and converted to a predetermined signal output by the corresponding detection area 301a to 301d.

On the other hand, the laser beam L1b from the red semiconductor laser 120b is reflected by the selector film 111b, transmitted through the diffraction element 211, and diffracted by the diffraction element 212, and guided to the collimator lens 220. Thereafter, like the blue laser beam L1a explained before, the laser beam L1b transmitted through the object lens 250 is guided on the recording surface of the optical disc D.

The reflected beam L2b from the recording surface of the optical disc D is, like the blue laser beam L1a, captured by the object lens 250, reflected by the polarized beam splitter 230, and guided to the detection optical system 260.

The laser beam L1c from the infrared semiconductor laser 120c is reflected by the selector film 111c, transmitted through and diffracted in a predetermined direction by the diffraction element 211, and transmitted through the diffraction element 212, and guided to the collimator lens 220. Thereafter, like the blue laser beam L1a and the red laser beam L1b explained before, the laser beam L1c transmitted through the object lens 250 is guided on the recording surface of the optical disc D.

The reflected beam L2c from the recording surface of the optical disc D is, like the blue laser beam L1a and the red laser beam L1b, captured by the object lens 250, reflected by the polarized beam splitter 230, and guided to the detection optical system 260.

As explained above, since the semiconductor laser elements which can output three laser beams of different wavelength, as shown in FIGS. 2A and 2B, are stacked in the direction vertical to the active layer stacking direction, it is possible to exactly control the interval between the emitting points of each laser element. Thus, by setting the interval between the wavelength selector films of the wavelength selector film block 111 corresponding to the interval between the laser beams emitted from the emitting points 122a, 122b and 122c, it is possible to guide the laser beams outputted from each laser element to the collimator lens 220 along the optical axis of optical system.

Therefore, it is possible to arrange the collimator 220, polarized beam splitter 230, object lens 250, detection optical system 260 and photo-detector 301 to be common to the three laser beams of different wavelength. Thus, the number of parts, weight and assembling cost of the optical head 1 can be greatly decreased.

The diffraction elements 211 and 212 may be arranged at desired positions, for example, between the collimator lens 220 and the polarized beam splitter 230, or between the object lens 250 and the polarized beam splitter 230.

The diffraction elements 211 and 212 of the compensation optical member 210 can be integrated as a single member by forming on both sides of one nitric material a groove pattern to compensate the dichroic/spherical aberration caused by combination with the collimator lens 220. Thus, it is possible to simplify optical adjustment when assembling the optical head 1.

Further, the diffraction elements 211 and 212 may be formed by a polarizing hologram.

When obtaining a track error signal by a 3-beam method, a third diffraction grating having a desired pitch (not shown) may be provided between the diffraction elements 211, 212 and the polarized beam splitter 230. In this case, the third diffraction grating can be located at a desired position like between the diffraction elements 211 and 212, between the ¼ wave plate 240 and the polarized beam splitter 230, as explained above. Similarly, it is also possible to form the third diffraction grating by a polarizing hologram, and provide at a desired position, for example, between the light source unit 100 and the ¼ wave plate 240.

Though the examples shown in FIG. 1A and FIGS. 2A, 2B uses three semiconductor laser elements which can output laser beams of different wavelength, wavelength selector films corresponding to the laser beam wavelengths, and compensation optical members (two diffraction elements 211 and 212) which compensate the chromatic/spherical aberration caused by the different wavelengths; the same effect can be obtained by using four or more semiconductor laser elements which can output laser beams of different wavelength, wavelength selector films corresponding to each laser beam wavelength, and three or more diffraction elements (three diffraction patterns) which compensate the chromatic/spherical aberration caused by the different wavelengths.

Description will now be given on another example of the light source unit 100 which uses the wavelength selector film block 111 shown in FIG. 2A with reference to FIGS. 3A and 3B.

The semiconductor laser unit 130 applicable to the light source unit 100, controls the laser beam emitting position in the direction parallel to an active layer. Namely, in the semiconductor laser unit 130, the active layers 131a to 131c included the laser element are located on the same plane, and the interval between the emitting points 132a to 132c aligned in the same direction of a predetermined straight line M2 on the same plane in parallel with the active layers, is controlled to be a predetermined value.

With the above-mentioned semiconductor laser unit 130 whose light-emitting points are controlled in the direction parallel to the active layers, the time required for creating a laser element can be reduced, compared with the method of piling up laser elements inserting each active layer which can output a predetermined wavelength laser beam.

Description will now be given on another example of the light source unit 100 which uses the wavelength selector block 111 shown in FIG. 2A by referring to FIG. 4.

The semiconductor laser unit 140 applicable to the light source unit 100 includes light-emitting points 142a to 142c, or active layers 141a to 141c, located at predetermined positions, according to the distance that the laser beam from an optional laser element passes through the wavelength selector films 111a to 111c of the wavelength selector film block 111.

Namely, from the position of the light-emitting point 142a, the light-emitting point 142b of the semiconductor laser element 140b is located at the position to be shifted along the optical axis of optical system toward the wavelength selector film block 111 by the distance substantially equivalent to the thickness of the wavelength selector film 111a, and the light-emitting point 142c of the semiconductor element 140c is shifted toward the wavelength selector film block 111 by the distance substantially equivalent to the sum of the thickness of the wavelength selector films 111a and 111b.

The semiconductor laser unit 140 arranged as above can give the wavelength selector film block 111 the effect similar to the effect obtained by the technique to improve the spherical aberration, and can improve the aberration caused by the change in the distance between each laser element 140a to 140c and the collimator lens 220.

FIG. 5 is a schematic diagram explaining an example using the light source unit 400 for the optical head 1, instead of the optical source unit 100 shown in FIGS. 2A, 2B and FIGS. 3A, 3B and FIG. 4.

As shown in FIG. 5, the light source unit 400 includes a semiconductor laser unit 150 which can output at least two or more laser beams, and three laser beams in this embodiment, of different wavelength.

The semiconductor laser unit 150 is formed by stacking sequentially the first semiconductor laser element 150a, the second semiconductor laser element 150b and the third semiconductor laser element 150c at predetermined positions.

The first laser element 150a emits a blue laser beam (e.g., a wavelength of 405 nm). The second laser element 150b emits a red laser beam (e.g., a wavelength of 650 nm). The third laser element 150c emits an infrared laser beam (e.g., a wavelength of 780 nm).

As shown in FIG. 5, the semiconductor laser unit 150 controls the laser beam emitting position in the direction vertical to an active layer. Namely, the active layers 151a, 151b and 151c of the laser elements 150a, 150b and 150c are stacked in the direction vertical to the area direction of the active layers. The laser element 150a and the laser element 150b have the predetermined interval, related to the wavelengths of the output laser beams, between the active layer 151a and the active layer 151b. Also the laser element 150b and the laser element 150c have a predetermined interval, related to the wavelengths of the output laser beams, between the active layer 151b and the active layer 151c.

Therefore, the corresponding light-emitting points 152a to 152c can be aligned along the predetermined straight line M3 orthogonal to the area direction of each active layer. The distance d1 between the light-emitting points 152a and 152b (the active layers 151a and 151b) and the distance d2 between the light-emitting points 152b and 152c (the active layers 151b and 151c) are set according to each laser beam of the laser element 150a to 150c have a different wavelength. The distances d1 and d2 are preferably short, and can be controlled by forming the layers of semiconductor laser elements 150a to 150c thin.

The semiconductor laser unit 150 shown in FIG. 5 does not require a wavelength selector film block, and the cost including the assembling, including optical adjustment, cost can be reduced.

However, since it is difficult to coincide the principal rays of all laser beams with the optical axis of optical system defined between the object lens, it is unavoidable to generate a laser beam whose color is likely influenced by aberration.

Thus, it is preferable to arrange the laser unit 150, so that the principal ray of the laser element 150a which outputs a short wavelength light such as a blue laser beam, coincides the optical axis of optical system included the optical head 1. Therefore, the above-mentioned distances d1 and d2 between the light-emitting points is controlled to be the predetermined interval related to the wavelengths of the laser beams outputted from the semiconductor laser elements 150b and 150c, on the basis of the light-emitting point 152a of the laser element 150a. Though the semiconductor laser elements which outputs blue, red and infrared laser beams are arranged in this order in the laser unit 150 in the embodiment of the invention, it will be appreciated that the order and the distance in the direction vertical to the active layer at each light-emitting point are set by the above-mentioned elements.

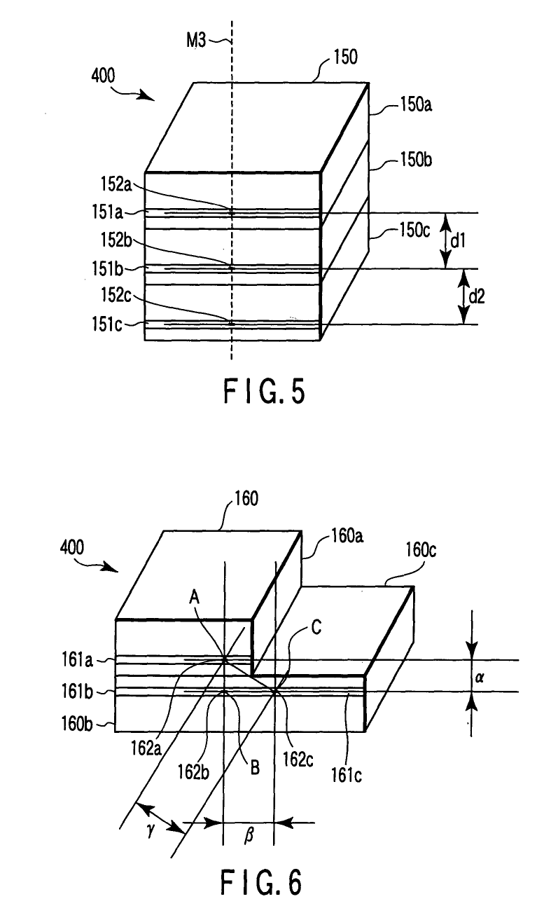

FIG. 6 is a schematic diagram explaining another example different from the light source unit 400 explained by referring to FIG. 5.

As shown in FIG. 6, the light source unit 400 includes a semiconductor laser unit 160 which can output at least two or more laser beams, and three laser beams in this embodiment, with different wavelengths.

The semiconductor laser unit 160 has a semiconductor laser element 160a for a blue laser beam for which the highest position accuracy is demanded, a semiconductor laser element 160b for a red laser beam, and a semiconductor laser element 160c for an infrared laser beam. The semiconductor laser elements 160b and 160c are the monolithic integrated 2-wavelength laser elements (e.g., T-WIN-LD structure) whose light-emitting points 162b and 162c are aligned in the direction parallel to the active layers 161b and 161c on the same plane.

The distance a between the light-emitting points 162a and 162b, or the active layers 161a and 161b, the distance β between the light-emitting points 162b and 162c, or the active layers 161b and 161c, and the distance γ between the light-emitting points 162a and 162c, or the active layers 161a and 161c, are set according to each laser beam wavelength of semiconductor laser elements 160a to 160c. Like the semiconductor laser unit 150 explained by referring to FIG. 5, the distances α and β between the light-emitting points 162a, 162b and 162c are preferably short, and can be controlled by forming each layer of semiconductor element thin.

Therefore, it is possible to reduce the cost lower than the cost of the light source unit shown in FIG. 5. The light-emitting points 162a to 162c of the laser elements are preferably arranged close to each other. The proximity is set by the size of a sectional beam spot of each laser beam in the optical disc D, and the area to supply energy used for securely recording and playback of information.

However, since it is difficult even with the structure shown in FIG. 6 to coincide the principal rays of all laser beams with the optical axis of optical system defined between the object lens 240, it is unavoidable to generate a laser beam of the color likely to be influenced by aberration.

Therefore, it is preferable to arrange the laser unit 160, so that the principal ray of the laser element 160a which outputs a blue laser beam, for example, coincides with the optical axis of optical system included the optical head 1, and to arrange the active layers 161b which outputs a red laser beam and 161a close to each other. Therefore, the above-mentioned distance a between the light-emitting points can be reduced by forming the layers of each semiconductor element, so that the light-emitting point 162a of the laser element 160a arranged on the optical axis of the optical head 1 becomes close to the light-emitting point of the semiconductor laser 160b.

In the example shown in FIG. 6, though the light-emitting point 162c of the laser element 160c for an infrared beam becomes farthest from the optical axis, this arises no practical problem because the sectional beam spot size of the infrared laser beam is larger than the sectional beam spot size of a red laser beam.

In the example explained by referring to FIG. 6, the light-emitting point 162a of the blue laser element 160a and the light-emitting point 162b red laser element 160b are aligned in the direction vertical to the active layer. It is allowable that the active layer 161b of the red laser 160b is substantially parallel to the active layer 161a of the blue laser element 160a, and their light-emitting points are arranged close to each other.

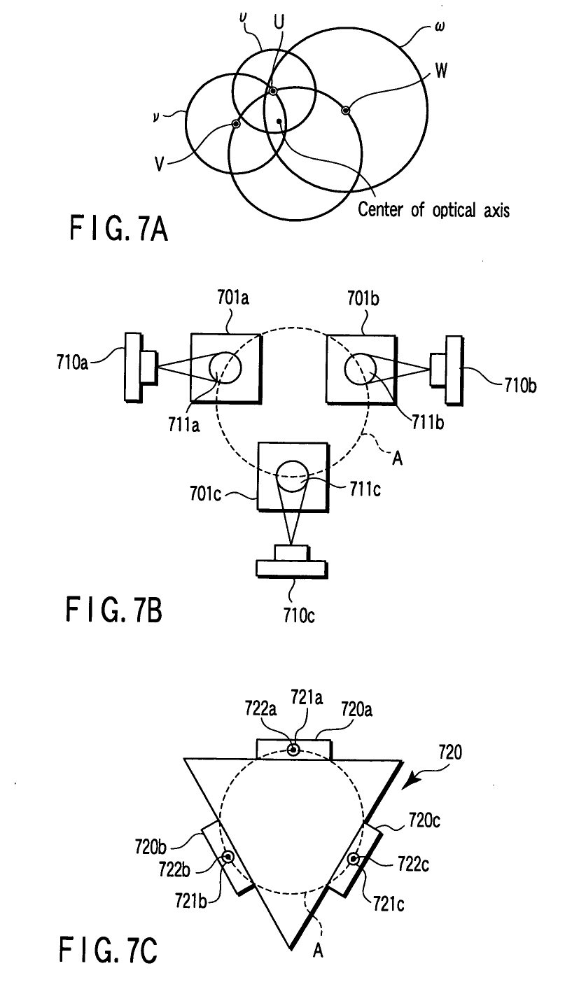

FIGS. 7A, 7B and 7C show schematic diagrams explaining an example using still another light source unit different from the light source unit 400 for the optical head 1, instead of the optical source unit 100 shown in FIGS. 2A, 2B and FIGS. 3A, 3B and FIG. 4.

In the above-explained light source units 100 and 400, at leas one of the three laser beams from the three semiconductor laser elements which output each laser beam of different wavelength, is located so that the principal ray of the laser beam coincides with the optical axis of optical system included the optical head 1. However, actually, it is required to exactly control the thickness of the selector film of the wavelength selector film block, or to specially arrange the active layers.

Therefore, it becomes possible as a semiconductor laser unit to use the three easily available laser beams by leading the three laser beams L1 (see FIG. 1) from the three semiconductor laser elements which output each laser beam of different wavelength, on the optical disc D from the object lens 250 along the optical axis of optical system included the optical head 1, and leading the laser beam L2 reflected by the optical disc D to the photodetector 301.

For example, as shown in FIG. 7A, arrange three semiconductor laser elements U, V and W on the same circle, and locate the optical axis of optical system included the optical head 1 in the area where the aberration allowable circles u, v and w which indicate the allowable aberration of each laser beam from the semiconductor laser elements, are overlapped. Therefore, it is possible to minimize the aberration by guiding the laser beams from the three semiconductor laser elements on the optical disc D with a single optical system, or by guiding the laser beams reflected by the optical disc to the photodetector 301 (see FIG. 1).

As shown in FIG. 7B, the semiconductor laser unit 710 has semiconductor laser elements 710a, 710b and 710c mounted at optional positions when incorporating the semiconductor laser elements as light source in the optical head 1. The optional positions mean the positions where the principal ray of three lights 711a, 711b and 711c bent substantially vertically by the rising mirrors (optical path bending mirrors) 701a, 701b and 701c, exist on the plane orthogonal to the optical axis of optical system the optical head 1 indicated by the circle A with an optional diameter.

This greatly increases the degree of freedom when arranging the semiconductor laser elements 710a, 710b and 710c. In this method, it is unnecessary to incorporate the semiconductor laser elements 710a, 710b and 710c in the same package, and three lights can be easily arrange on a circle on a plane vertical to the optical axis of optical system the optical head 1. The diameter of the circle A is set, so that the sum of aberration, or shift each focal point where the semiconductor laser beams are condensed on the optical disc and the optical axis of the optical system which guides the beam from light source on the optical disc, becomes minimum.

As shown in FIG. 7C, it is also possible to arrange the three laser elements 720a, 720b and 720c on the circle A.

In this case, it is permitted to fix the semiconductor unit 720 to an optional fixing member, so that the laser elements 720a, 720b and 720c (preferably the light-emitting points 721a, 721b and 731c) are arranged on the circle A. As shown in FIG. 7C, the fixing member is an equilateral triangle, for example, and each semiconductor laser element is fixed to each side of the triangle.

In the semiconductor unit 720, the principal ray of the laser beam from the semiconductor laser element does not coincide with the optical axis of the optical head, but the manufacturing process can be simplified compared with the semiconductor unit stacked in the semiconductor manufacturing process such as growing.

As explained above, with the light source units 710 and 720 of the present invention, it is possible to guide a plurality of laser beams outputted from an optional number of semiconductor laser elements on the recording surface of the optical disc by using a common optical system in which a single optical axis exist, and to guide the reflected light from the optical disc to a single photodetector.

In the example explained by referring to FIGS. 7A, 7B and 7C, three laser beams of different wavelengths can be used with a single optical system. The example is also applicable to four laser beams of different wavelength, for example. Namely, by leading three laser beams of different wavelength to the object lens within the area of the circle A set so that the sum with the aberration becomes minimum, the single optical system can be used for any wavelength laser beam. With this structure, the integration degree of components is lowered compared with the example shown in FIGS. 5 and 6 where the semiconductor laser unit is specially arranged, or the example shown in FIGS. 2 to 4 which uses the wavelength selector film block, but it is possible to guide a plurality of laser beams of different wavelengths on the optical disc through a single optical system at a low cost, and to process the reflected laser beam from the optical disc by the same signal processing system, without influencing the size of the optical disc.

Next, explanation will be given on an example of an optical disc unit provided with the optical head 1 shown in FIG. 1 with reference to FIG. 8.

Here, explanation will be concentrated on the playback of the signal obtained by the optical head 1.

The photodetector 301 includes 1^{st} to 4^{th} area photodiodes 301A, 301B, 301C and 301D. The outputs A, B, C and D of these photodiodes are amplified to predetermined level by 1^{st} to 4^{th} amplifiers 21a, 21b, 21c and 21d.

Among the outputs A to D from the amplifiers 21a to 21d, A and B are added by a first adder 22a, C and D are added by a second adder 22b. The outputs of the adders 22a and 22b are applied to a third adder 23, where (C+D) is subtracted from (A+B), and the output is supplied to a focus control circuit 31 as a focus error signal to coincide the position of the object lens 7 with a focal length, that is, the distance at which a light focused by the object lens 7 and the position of predetermined depth of a not-shown track or a not-shown series of pits on the recording surface of the optical disc D.

On the other hand, the adder 24 creates (A+C), and the adder 25 creates (B+D). These (A+C) and (B+D) are applied to a phase difference detector 32. The phase difference detector 32 is useful to exactly output a tracking error signal, even if the object lens 250 is shifted.

The adder 26 calculates (C+D) from (A+B), and supplies it to a tracking control circuit as a tracking error signal.

Further, the adder 27 adds (A+B) and (B+D), converts them to a (A+B+C+D) signal or a playback signal, and stores in a buffer memory 34.

An APC circuit 39 receives the intensity of the return light from an optional laser element of the light source unit 100, and controls the light strength emitted from an optional laser element of the light source 100 to a predetermined level, based on the recording data stored in a recording data memory 36.

In the optical disc unit having the above-mentioned signal detection system, when the optical disc D is set on a turntable 14 and a predetermined routine is started by a CPU 38, a motor drive circuit 35 rotates a drive motor 13 at a predetermined speed, and a laser drive circuit 37 controls the light source unit 100 to radiate from an optional laser element a playback laser beam to the recording surface of the optical disc D.

Thereafter, another optional laser element of the light source unit 100 emits a playback laser beam successively, and the signal playback operation is started, though the detailed description is omitted.

The present invention is not to be limited to the above-mentioned embodiments, and may be embodied in other specific forms without departing from its spirit or essential characteristics. Each embodiment may be embodied by combining appropriately as far as possible. In that case, the effect by the combination will be obtained.

As explained hereinbefore, the optical head of the present invention can guide laser beams with optional wavelengths emitted from a plurality of laser elements which can output laser beams of different wavelengths to a recording medium through a pair of collimator lens, a beam splitter and object lens, and can obtain a playback signal from a light with one of the wavelengths reflected by the recording medium through a common detection optical system, a photodetector and a signal processing system. Therefore, the number, weight and size of the parts constituting an optical head and the assembling cost can be greatly reduced.

The present invention is not limited to the embodiments described above and can be modified in various manners without departing from the spirit and scope of the invention.

For example, the present invention can provide an optical head, which comprising: plural light-emitting parts each of which output light rays of a different wavelength;

an integrated light source which includes a wavelength selector film to convert the optical axis of each light ray from the light-emitting part to a single optical axis;

a photodetector which output a signal output corresponding to the incident light;

optical system which guides each light rays from the integrated light source to the recording surface of a recording medium along a single optical axis; and

reflection optical system which guide each reflected light rays from the recording surface to the photodetector which performs signal processing of each of light rays from said light source, along a single optical axis.

The present invention can also provide an optical head, which comprising: plural light-emitting parts each of which output light rays of a different wavelength;

an integrated light source which includes a wavelength selector film to convert the optical axis of each light ray from the light-emitting part to a single optical axis;

a photodetector which output a signal output corresponding to the incident light;

optical system which guides each light rays from the integrated light source to the recording surface of a recording medium along a single optical axis; and

reflection optical system which guide each reflected light rays from the recording surface to the photodetector which performs signal processing of each of light rays from said light source, along a single optical axis; wherein the light-emitting parts are stacked in the direction vertical to the area direction of the active layers including light emitting points; and

the light-emitting points are arranged in series with a desired interval, which is controlled by the active layer thickness.

Still further, the present invention can provide an optical head, which comprising: plural light-emitting parts each of which output light rays of a different wavelength;

an integrated light source which includes a wavelength selector film to convert the optical axis of each light ray from the light-emitting part to a single optical axis;

a photodetector which output a signal output corresponding to the incident light;

optical system which guides each light rays from the integrated light source to the recording surface of a recording medium along a single optical axis; and

reflection optical system which guide each reflected light rays from the recording surface to the photodetector which performs signal processing of each of light rays from said light source, along a single optical axis; wherein active layers including the light-emitting points of the light-emitting parts are arranged on the same plane; and

the light-emitting points are arranged on a single straight line with a desired interval.

Further another, the present invention can provide an optical head, which comprising: plural light-emitting parts each of which output light rays of a different wavelength;

an integrated light source which includes a wavelength selector film to convert the optical axis of each light ray from the light-emitting part to a single optical axis;

a photodetector which output a signal output corresponding to the incident light;

optical system which guides each light rays from the integrated light source to the recording surface of a recording medium along a single optical axis; and

reflection optical system which guide each reflected light rays from the recording surface to the photodetector which performs signal processing of each of light rays from said light source, along a single optical axis; wherein the wavelength selector film block is corrected in the distance between each light-emitting point of the light-emitting parts and the recording surface of the recording medium, according to the variations in the optical path length to be changed.

Still further, the present invention can provide an optical head, which comprising: plural light-emitting parts each of which output light rays of a different wavelength;

an integrated light source which includes a wavelength selector film to convert the optical axis of each light ray from the light-emitting part to a single optical axis;

a photodetector which output a signal output corresponding to the incident light;

optical system which guides each light rays from the integrated light source to the recording surface of a recording medium along a single optical axis; and

reflection optical system which guide each reflected light rays from the recording surface to the photodetector which performs signal processing of each of light rays from said light source, along a single optical axis; wherein the light-emitting parts are at least three or more;

at least two of the light-emitting parts are stacked in the direction vertical to the area direction of the active layers which include the light-emitting points;

light-emitting points of at least two of the light-emitting parts are arranged in series with a desired interval, which is controlled by the thickness of the active layer; and

a remaining light-emitting part includes a light-emitting point arranged on a single straight line with a desired interval between one of said two light-emitting parts, and an active layer arranged parallel to the area direction of one of the active layers of said two light-emitting parts.

Further another, the present invention can provide an optical head, which comprising:

a light source which performs recording and/or playback of the information on the optical disc;

an object lens which focuses the light ray emitted from the light source on to the information recording layer through the light transparent layer of the optical disc;

a branching portion which branches a reflected luminous flux from the optical disc to between the light source and the object lens;

a detection lens which focuses the light ray branched by the branching portion; and

a light receiving portion which receives light ray and generates a light intensity signal according to the intensity of the received light ray; wherein

the light source has plural light-emitting parts which each output light ray of a different wavelength; and

the light-emitting parts are arranged in a circle on a plane vertical to the optical axis of the object lens.

Still further, the present invention can provide an optical head, which comprising:

a light source which performs recording and/or playback of the information on the optical disc;

an object lens which focuses the light ray emitted from the light source on to the information recording layer through the light transparent layer of the optical disc;

a branching portion which branches a reflected luminous flux from the optical disc to between the light source and the object lens;

a detection lens which focuses the light ray branched by the branching portion; and

a light receiving portion which receives light ray and generates a light intensity signal according to the intensity of the received light ray; wherein

the light source has plural light-emitting parts which each output light ray of a different wavelength; and

the light-emitting parts are arranged in a circle on a plane vertical to the optical axis of the object lens; wherein the light-emitting parts of the light source are arranged in a circle without stacking three or more semiconductor laser elements; and

said three or more semiconductor laser elements are all packaged in one element.

Further another, the present invention can provide an optical disc apparatus, which comprising:

an optical head having plural light-emitting parts each of which outputs light ray of a different wavelength, an integrated light source which consists of a wavelength selector film to convert the optical axes of the light-emitting parts to a single optical axis, a photodetector which outputs a signal corresponding to the incident light ray, optical system which guides the light rays from the light source to the recording surface of a recording medium along a single optical axis, and reflection optical system which guides the light ray from the light source to the photodetector which can perform signal processing of the light, along a single optical axis;

a laser drive circuit which outputs light of a predetermined wavelength from an optional light-emitting part of the optical head;

a signal processor which plays information recorded on the recording medium, based on the signal output from the photodetector of the optical head; and

a motor which rotates the recording medium at a predetermined speed.

Still further, the present invention can provide an optical disc apparatus, which comprising:

an optical head having a light source performs recording and/or playback of information on the optical disc, an object lens which focuses the light emitted from the light source on to the information recording layer through the light transparent layer of the optical disc, a branching portion which branches reflected luminous flux from the optical disc to between the light source and the object lens, a detection lens which focuses the light branched by the branching portion, and a light receiving portion which receives light and generates a light intensity signal according to the intensity of the received light ray, wherein the light source of the optical head has plural light-emitting parts which each output light of a different wavelength, and each of the light-emitting parts is arranged in a circle on a plane vertical to the optical axis of the object lens;

a laser drive circuit which outputs light of a predetermined wavelength from an optional light-emitting part of the optical head;

a signal processor which plays information recorded in the recording medium, based on the signal output from the photodetector of the optical head; and

a motor which rotates the recording medium at a predetermined speed.

Further another, the present invention can provide an optical disc apparatus, which performs at least one of recording and playback of an optical disc having an information recording layer and a light transparent layer to protect the information recording layer, and has an optical head comprising:

a light source which is necessary to perform one of recording and playback of the information of the optical disc;

an object lens which focuses the light emitted from the light source to the information recording layer through the light transparent layer of the optical disc;

a branching portion which branches a reflected luminous flux from the optical disc to between the light source and the object lens;

a detection lens which focuses the light branched by the branching portion;

a light receiving portion which receives a light and generates a light intensity signal according to the intensity of the received light;

plural light sources of different wavelength; and

a packaged light source which can align the optical axes of plural light rays of a different wavelength, by using a rising mirror with a wavelength selector film.

Still further, the present invention can provide an optical disc apparatus, which performs at least one of recording and playing an optical disc having an information recording layer and a light transparent layer to protect the information recording layer, and has an optical head comprising:

a light source which is necessary to perform one of recording and playback of the information of the optical disc;

an object lens which focuses the light emitted from the light source to the information recording layer through the light transparent layer of the optical disc;

a branching portion which branches a reflected luminous flux from the optical disc to between the light source and the object lens;

a detection lens which focuses the light branched by the branching portion;

a light receiving portion which receives a light and generates a light intensity signal according to the intensity of the received light; and

plural light sources of different wavelength; wherein one of the light sources is located on the optical axis of an optical system, and aberration is reduced by locating plural light-emitting points closed to each other by forming a laser element film thin.

Further another, the present invention can provide an optical disc apparatus, which performs at least one of recording and playback of an optical disc having an information recording layer and a light transparent layer to protect the information recording layer, and has an optical head comprising:

a light source which is necessary to perform one of recording and playback of the information of the optical disc;

an object lens which focuses the light emitted from the light source to the information recording layer through the light transparent layer of the optical disc;

a branching portion which branches a reflected luminous flux from the optical disc to between the light source and the object lens;

a detection lens which focuses the light branched by the branching portion;

a light receiving portion which receives a light and generates a light intensity signal according to the intensity of the received light; and

plural light sources of different wavelength; wherein

the optical heads are arranged in a circle on a plane vertical to the optical axis entering the object lens.

Still further, the present invention can provide an optical head, which comprising:

plural light-emitting parts each of which can output light rays of a different wavelength;

a photodetector which can output a signal output corresponding to the incident light;

optical system which guide each light rays from the integrated light source to the recording surface of a recording medium along a single optical axis; and

reflection optical system which guide each reflected light rays from the recording surface to the photodetector which can perform signal processing of each of light rays from said light source, along a single optical axis; wherein

a wavelength selector film block, which reflects the lights from the light-emitting points of the light sources at different positions according to the different wavelengths, and locates the lights on the same axial line or in proximity to the line, is located between the light source and the optical system.

Further another, the present invention can provide an optical head, which comprising:

plural light-emitting parts each of which can output light rays of a different wavelength;

a photodetector which can output a signal output corresponding to the incident light;

optical system which guide each light rays from the integrated light source to the recording surface of a recording medium along a single optical axis; and

reflection optical system which guide each reflected light rays from the recording surface to the photodetector which can perform signal processing of each of light rays from said light source, along a single optical axis; wherein

the light source includes three or more light-emitting points which can output lights of different wavelength, and the lights from the light-emitting points are concentrated in a circle on a plane orthogonal to the axial line passing through the optical system.

Still further, the present invention can provide an optical head, which comprising:

plural light-emitting parts each of which can output light rays of a different wavelength;

a photodetector which can output a signal output corresponding to the incident light;

optical system which guide each light rays from the integrated light source to the recording surface of a recording medium along a single optical axis; and

reflection optical system which guide each reflected light rays from the recording surface to the photodetector which can perform signal processing of each of light rays from said light source, along a single optical axis; wherein

the light source includes three or more light-emitting points which can output lights of different wavelength, and the lights from the light-emitting points are arranged against the axial line passing through the optical system based on the intrinsic shift amount depending on the light wavelengths.

Further another, the present invention can provide an optical head, which comprising:

plural light-emitting parts each of which can output light rays of a different wavelength;

a photodetector which can output a signal output corresponding to the incident light;

optical system which guide each light rays from the integrated light source to the recording surface of a recording medium along a single optical axis; and

reflection optical system which guide each reflected light rays from the recording surface to the photodetector which can perform signal processing of each of light rays from said light source, along a single optical axis; wherein

the light source includes three or more light-emitting points which can output light rays of different wavelength, and the lights from the light-emitting points have a beam spot capable of providing the energy large enough to record information on the recording surface of the recording medium, and a part of the beam spot is arranged to have an area which overlaps at least in the plane orthogonal to the axial line passing through the optical system.

Further another, the present invention can provide an optical head, which comprising:

a light source unit which can output at least three light rays of different wavelength, so that at least one wavelength light or a part of each overlapped lights in a plane orthogonal to the axial line which is defined between a recording medium, is located on the axial line defined between the recording medium;

a compensation optical system which compensate the aberration of the light of optional wavelength outputted from the light source unit;

a light transmission system which includes a focusing lens, and guides the light of optional wavelength compensated by the compensation optical system to a recording medium;

a photoelectric converter which receives the reflected light from the recording medium captured by the focusing lens, and outputs a signal corresponding to the intensity of that light; and

a light receiving system which leads the light reflected by the recording medium to the photoelectric converter.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical head comprising a light source which performs recording and/or playback of the information on the optical disc, an object lens which focuses the light ray emitted from the light source to the information recording layer through the light transparent layer of the optical disc, a branching portion which branches reflected luminous flux from the optical disc to between the light source and the object lens, a detection lens which focuses the light ray branched by the branching portion, and a light receiving portion which receives light ray and generates a light intensity signal according to the intensity of the received light ray, wherein
the light source has plural light-emitting parts which each output light ray of a different wavelength; and
an optional light-emitting part among the light-emitting parts is arranged, so that the optical axis of the output light ray is located on the optical axis of the optical system.

2. An optical head according to claim 1, wherein
said plurality of light-emitting parts of the light source are stacked in series to the vertical direction of the active layers which include light-emitting points; and
the light-emitting points are arranged in series close to each other by the control of the active layer thickness.

3. An optical head according to claim 2, wherein
said plurality of light-emitting parts of the light source include a monolithic 2-wavelength laser element and a semiconductor laser element which can output a blue laser beam; and
active layer of the semiconductor laser element are stacked in the direction vertical to the face direction of active layer of the monolithic 2-wavelength laser element.

4. An optical head according to claim 2, wherein
each said light-emitting part is constructed such that α<β≦γ, assuming that the light-emitting point of the light source with the shortest wavelength is A, the light-emitting point with the next shortest wavelength is B, and the light-emitting point with the longest wavelength is C, and assuming that the distance between A and B is α, the distance between B and C is β, and the distance between C and A is γ.

5. An optical head according to claim 3, wherein
each said light-emitting part is constructed such that α<β≦γ, assuming that the light-emitting point of the light source with the shortest wavelength is A, the light-emitting point with the next shortest wavelength is B, and the light-emitting point with the longest wavelength is C, and assuming that the distance between A and B is α, the distance between B and C is β, and the distance between C and A is γ.

6. An optical disc apparatus comprising:
an optical head having a light source which is necessary to perform recording and/or playback of information on the optical disc, an object lens which focuses the light emitted from the light source on to the information recording layer through the light transparent layer of the optical disc, a branching portion which branches reflected luminous flux from the optical disc to between the light source and the object lens, a detection lens which focuses the light branched by the branching portion, and a light receiving portion which receives light and generates a light intensity signal according to the intensity of the received light ray, wherein the light source of the optical head has plural light-emitting parts which each output light of a different wavelength, and one of the light-emitting parts is arranged on the optical axis of the optical system;
a laser drive circuit which outputs light with a predetermined wavelength from an optional light-emitting part of the optical head;
a signal processor which plays information recorded on the recording medium, based on the signal output from the photodetector of the optical head; and
a motor which rotates the recording medium at a predetermined speed.

7. An optical head according to claim 6, wherein
said plurality of light-emitting parts of the light source are stacked in series to the vertical direction of the active layers which include light-emitting points; and
the light-emitting points are arranged in series close to each other by the control of the active layer thickness.

8. An optical head according to claim 7, wherein
said plurality of light-emitting parts of the light source include a monolithic 2-wavelength laser element and a semiconductor laser element which can output a blue laser beam; and
active layer of the semiconductor laser element are stacked in the direction vertical to the face direction of active layer of the monolithic 2-wavelength laser element.

9. An optical head according to claim 7, wherein
each said light-emitting part is constructed such that α<β≦γ, assuming that the light-emitting point of the light source with the shortest wavelength is A, the light-emitting point with the next shortest wavelength is B, and the light-emitting point with the longest wavelength is C, and assuming that the distance between A and B is α, the distance between B and C is β, and the distance between C and A is γ.

10. An optical head according to claim 8, wherein
each said light-emitting part is constructed such that α<β≦γ, assuming that the light-emitting point of the light source with the shortest wavelength is A, the light-emitting point with the next shortest wavelength is B, and the light-emitting point with the longest wavelength is C, and assuming that the distance between A and B is α, the distance between B and C is β, and the distance between C and A is γ.
